(19) United States
(12) Patent Application Publication
(10) Pub. No.: US 2006/0045583 A1
(43) Pub. Date: Mar. 2, 2006

(54) Cleaning device and process with multiple cleaning blades held by a common mount

(76) Inventors: Kurt E. Jones, Webster, NY (US); Borden H. Mills III, Webster, NY (US); Jeffrey H. Cokeley, Byron, NY (US)

Correspondence Address: Mark G. Bocchetti;Eastman Kodak Company, 343 State Street, Rochester, NY, 14650-2201, US

(21) Appl. No.: 10/928,935

(22) Filed: Aug. 27, 2004

(51) Int. Cl. G03G 15/20

(52) U.S. Cl. 399/327

(57) ABSTRACT

The invention relates to cleaning deposits from rollers in a fusing apparatus for a printer. Cleaning devices and processes for cleaning a moving surface in a printer are provided. According to just one aspect of the invention, a common mount is provided. A first cleaning blade defines a first edge configured to engage the moving surface in the printer and has a first marginal end opposite the first edge. A second cleaning blade defines a second edge configured to engage the moving surface in the printer and has a second marginal end opposite the second edge. The first marginal end and the second marginal end are held by the common mount.

### BACKGROUND

The invention relates to cleaning deposits from rollers in a fusing apparatus for a printer.

Variable information may be added to media pre-printed, for example by offset lithography, using digital printing machines, such as the Digimaster® 9110 available from Nexpress Solutions LLC, Rochester, N.Y. Pre-printed media may generate an unacceptable level of contamination of a fuser in a printer, and in particular, on an externally heated roller fuser. With pre-printed media generated by an offset printing process, the contamination is caused by transfer of offset inks and spray powder to the fuser components, and in particular the fuser roller. Such contamination typically causes image defects and release failure of printed/fused materials from the fuser roller. This results in frequent service calls to replace fuser parts.

### BRIEF DESCRIPTION OF THE DRAWINGS

FIG. 1 presents a schematic end view of a fuser assembly and process according to various aspects of the invention.

FIG. 2 presents a schematic top view of a cleaning device taken along line 2-2 of FIG. 1.

FIG. 3 presents a schematic top view of another embodiment of a cleaning device according to one aspect of the invention.

FIG. 4 presents a schematic top view of another embodiment of a cleaning device according to one aspect of the invention.

FIG. 5 presents a schematic end view of a moving surface and the cleaning device of FIG. 4 according to one aspect of the invention.

FIG. 6 presents a top view of a cleaning blade with a clip structure according to one aspect of the invention.

FIG. 7 presents a side view of the FIG. 6 cleaning blade and clip structure.

### DETAILED DESCRIPTION

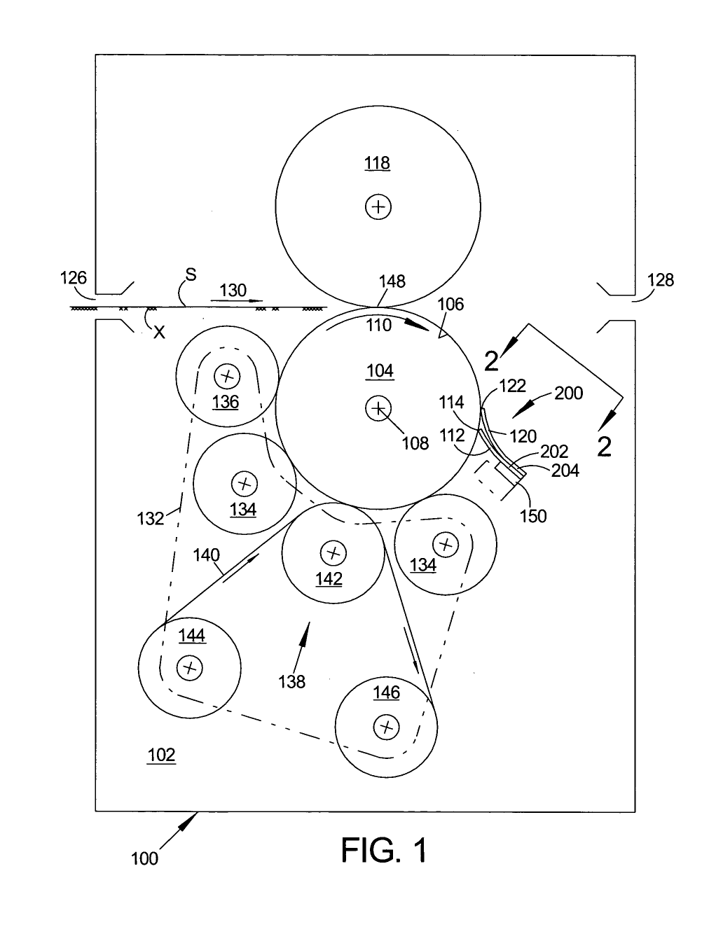

Various aspects of the invention are now presented with reference to the drawings, which are not drawn to any particular scale, and wherein like components in the numerous views are numbered alike. As used herein, “first”, “second”, and “third” are used for reference only, do not indicate any particular order, and are not intended to limit the invention. Referring now specifically to FIG. 1, a fuser assembly 100 for a printer is presented. According to an aspect of the invention, a cleaning device 200 for cleaning a moving surface 106 in a printer is provided. In the example presented in FIG. 1, the moving surface 106 is part of a fusing apparatus 100, but the invention can be used in other parts of a printer. The cleaning device 200 comprises a common mount 150. A first cleaning blade 112 defines a first edge 114 configured to engage the moving surface 106 and comprises a first marginal end 202 opposite the first edge 114. A second cleaning blade 120 defines a second edge 122 configured to engage the moving surface 106 and comprises a second marginal end 204 opposite the second edge 122.

The moving surface may be an outer circumferential surface of a roller 104 held by the support 102, the roller defining the circumferential surface and being rotatable about an axis 108 relative to the support 102. Another example of a moving surface is a fuser belt that defines the moving surface, which is also a fusing surface. A fuser belt system is disclosed in U.S. Pat. No. 6,096,427 issued Aug. 1, 2000 to Chen et al. This patent is hereby incorporated in its entirety by reference as if fully set forth herein. A fusing nip 148 may be formed with another roller 118, or a fuser belt.

A sheet S enters the fuser assembly 100 from the left through entry 126, passes through the fusing nip 148, and exits the fuser assembly 100 to the right through exit 128. Other configurations and are contemplated in the practice of the invention, the particular configuration not being critical in the practice of the invention. The sheet S has ink particles X deposited on it, for example by inkjet, electrographic, or other means that apply marking material to the sheet S, and the ink particles X may comprise ink, dye, and/or toner (fusible dry ink). The sheet S passes between the rollers 104 and 118 under pressure and/or heat, in the direction of arrow 130. This process fixes the ink particles X to the sheet S, as is well known in the art. As used herein “fuser” and “fusing” refers to apparatus and processes for stabilizing an image on a receiver by heat and/or pressure. Appropriate sheet handling apparatus (not shown) is provided within the fuser that carries the sheet S from the entry 126, through the nip between the rollers 104 and 118, and to the exit 128.

According to an aspect of the invention, a fusing process in a printer is provided comprising rotating the roller 104 held by the support 102 about the axis 108 relative to the support 102, the roller defining a circumferential surface 106. The common mount 150 is held by the support 102. The mount holds the first marginal end 202 of the first cleaning blade 112 that defines the first edge 114 opposite the first marginal end 202. The common mount 150 holds a second marginal end 204 of the second cleaning blade 120 that defines the second edge 122 opposite the second marginal end 204. The first edge 114 and the second edge 122 contact the circumferential surface 106.

According to an aspect of the invention, a fusing process in a printer is provided comprising moving a fusing surface (surface 106 for example) held by the support 102 in a direction 110 relative to the support 102. The support 102 holds the common mount 150 that holds the first marginal end 202 of the first cleaning blade 112 and the second marginal end 204 of the second cleaning blade 120. The first cleaning blade 112 defines the first edge 114 opposite the first marginal end 202, and the second cleaning blade 120 defines the second edge 122 opposite the second marginal end 204. The first edge 114 and the second edge 122 contact the fusing surface.

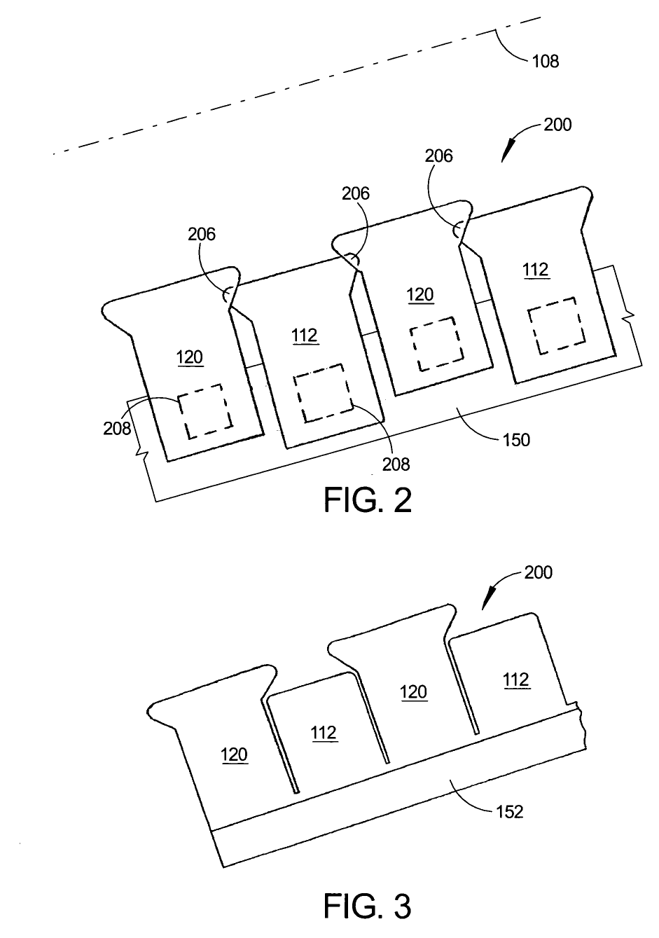

Referring now to FIG. 2, the first cleaning blade 112 and the second cleaning blade 120 may be superposed, as indicated at 206. The first cleaning blade 112 may be disposed at one position along the axis 108, and the second cleaning blade 120 being disposed at another position along the axis 108. In the embodiment of FIG. 2, the cleaning blades 112 and 120 comprise clip structures 208 that are received within mating openings in the common mount 150. One or more cleaning blades 112 and 120 may be replaced, as desired, merely by unclipping the blade and replacing it with another. As shown in FIG. 1, the tips 114 and 122 of the cleaning blades 112 and 120 splay away from each other (toward the moving surface 106) as the blade tips are deflected by the moving surface 106 (roller, circumferential surface, belt, etc.).

Referring now to FIG. 3, an embodiment of cleaning device 200 is presented wherein the first cleaning blade 112 and the second cleaning blade 120 are not superposed. The blades 112 and 120 may be formed from a single sheet as a contiguous blade, for example by photoetching, stamping, or laser cutting. Alternatively, the blades 112 and 120 may be separate blades held in a mount such as mount 150 by the clip structures 208, for example, as shown FIG. 2. Furthermore, an alternative common mount 152 is presented wherein the first and second cleaning blades 112 and 120 may be held within a C-shaped channel (retained). Innumerable variations are evident in light of the description provided herein.

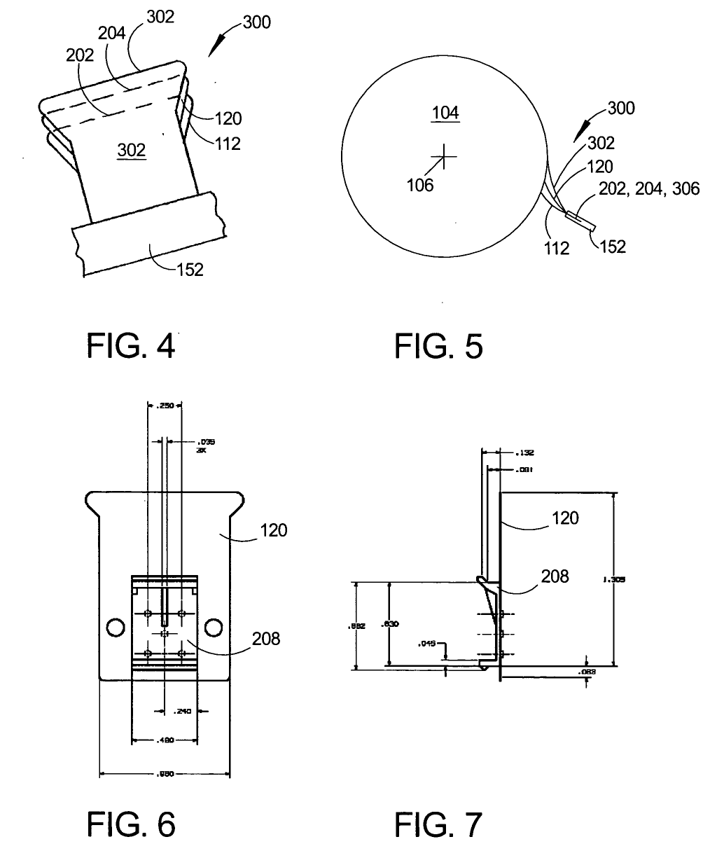

Referring now to FIGS. 4 and 5, a cleaning device 300 is presented comprising third cleaning blade 302 defining a third edge 304 in contact with the circumferential surface 106 (or other moving surface, as described herein) and comprising a third marginal end 306 opposite the third edge 304. The first marginal end 202, the second marginal end 204, and the third marginal end 302 may be held by a common mount, such as common mount 150 or 152. As shown in FIG. 4, the first cleaning blade 112, the second cleaning blade 120, and the third cleaning blade 302 splay away from each other toward the roller 106 (or other moving surface). The first cleaning blade 112, the second cleaning blade 120, and the third cleaning blade 302 may be superposed with adjacent blades, as shown in FIG. 2, and they may be more fully superposed relative to each other as shown in FIG. 4. In the embodiment of FIG. 4, the cleaning blades may be immediately adjacent each other (actually in contact) at their marginal ends. Of course, they can spaced some distance from each other at their marginal ends.

The cleaning device 200, 300, etc., may be constructed as separate replaceable units.

The moving surface 106 (circumferential surface, fusing surface, etc.) may comprise material deposited from pre-printed media, for example offset ink and/or powder. The powder is applied to inhibit smearing, offsetting, and blocking in an offset printing process, as is described on pages 176 and 249-250 of Hemult Kipphan, HANDBOOK OF PRINT MEDIA (Springer 2001), and is residual on pre-printed media. According to one aspect of the invention, the cleaning blades remove such material. Of course, the cleaning blades may be implemented to remove contamination from any source.

Referring now to FIGS. 6 and 7, the cleaning blade 120 is presented with a detailed view of one example of the clip structure 208 that may be implemented in the practice of the invention. The dimensions in FIGS. 6 and 7 are in inches. The clip 208 is received within a corresponding rectangular hole in the mount 150. The clips 208 may be formed from a high temperature resistant plastic. A high temperature injection moldable thermoplastic, such as polyetherimide, may be implemented. An example of a suitable material is Ultem® 1000 Black polyetherimide available from the General Electric Company, USA. The clips 208 may be mechanically fastened, bonded, welded, or molded to the blades 112, 120, etc. In the example presented in FIGS. 6 and 7, the clips 208 are provided with posts that extend through receiving holes in the cleaning blade 120, and the ends are flattened by ultrasonic welding. The outside diameter of the posts may be increased to provided increased resistance to skiving forces. Other mounting techniques may also be implemented to increase resistance to skiving forces, for example outsert molding.

The material of cleaning blades 112, 120, etc., may be any material capable of withstanding the heat and abrasiveness of the fuser and/or pressure rollers or other surface to which it is applied. One example of a suitable material is a thin spring steel between 0.002 and 0.006 inches thick. A 0.004 inch thick extra spring temper cold rolled steel strip may be implemented. The included angle of contact between the blade and a tangent to the surface at the point of contact with the moving surface 106 may be on the order of 0 to 30 degrees, inclusive, and may be on the order of 10 to 20 degrees, inclusive. The tip force perpendicular to the moving surface 106 at the point of contact may be on the order of 1 ounce to 5 ounces per linear inch, inclusive, and may be between 2 ounces and 4 ounces per linear inch, inclusive.

The support 102 may take any suitable configuration. It generally comprises a frame and is composed of numerous separate components although a simple fuser may have a monolithic support. The support 102 may comprise one or more additional supports 132 (shown in phantom in FIG. 1). The components may be interconnected by bonding, welding, mechanical fastening, or any other suitable method. Such assemblies are typically fabricated for subsequent disassembly in order to provide ready access to replaceable parts.

The fusing surface may be heated. Generally, heating is accomplished internally or externally. In the example of FIG. 1, a pair of heating rollers 134 are provided that contact the circumferential surface 106. The heating rollers 134 have internal radiant heaters, for example heat lamps. Any type of heating may be implemented in the practice of the invention.

Furthermore, a surface treatment may be applied to the moving surface 106 by a roller 136, as described in Provisional Patent Application Ser. No. 60/540,883 entitled “METHOD AND APPARATUS FOR VARIABLE WIDTH SURFACE TREATMENT APPLICATION TO A FUSER”, filed Jan. 30, 2004, the contents of which are hereby incorporated by reference as if fully set forth herein. As described in that application the surface treatment may be a substance that promotes release of the fused sheet from the fuser roller 104, for example silicone oil. The roller 136 may be a porous wick roller, for example a porous ceramic cylinder covered with fabric. Silicone oil may be fed to it from a perforated tube disposed inside the ceramic cylinder.

Additional cleaning may be added, as described in Provisional Patent Application Ser. No. 60/582,482 entitled “VARIABLE FUSER FOR PRINT MEDIA”, filed Jun. 24, 2004, the contents of which are hereby incorporated by reference as if fully set forth herein. In the embodiment of FIG. 1, a web cleaner 138 is provided that incrementally moves a web 140 over the surface of a tensioner roller 142 from a supply roll 144 to a take-up roll 146. An example of a web cleaner that may be implemented is described in U.S. Pat. No. 6,631,251, issued Oct. 7, 2003, entitled “Fuser web cleaning assembly for an electrophotographic machine”, the contents of which are hereby incorporated by reference as if fully set forth herein. The web 140 may be comprised of any flexible, cleaning material which is capable of removing contaminants from fuser surface 106 upon contact (e.g. woven cloth-like material such as a NOMEX® aromatic polyamide fiber) without damaging it. Alternatively, or in addition, the web cleaner 138 may be applied to one or both heating rollers 134.

The heating roller 134, roller 136, and cleaning assembly 138, may be held by one or more additional supports 132 (shown in phantom) that, in turn, are held by the support 102. The exact configuration is not critical in the practice of the invention to the extent that the components do not interfere with each other and the sheet S is free to move through the fuser assembly 100 without obstruction.

In the embodiments described herein with reference to FIG. 1, the roller 104 comprises a fuser roller but, according to a further aspect of the invention, the first cleaning blade 112 could also be applied to a pressure roller, such as roller 118. Furthermore, the first cleaning blade 112 could be applied to both fuser roller 104 and pressure roller 118. Likewise, the second cleaning blade 120 could be applied to both the fuser roller 104 and the pressure roller 118. It is intended for these variations to be included within the scope of the claims.

A fuser roller 104 may comprise a core, for example made of aluminum, and a cylindrical fusing blanket supported on the core. The blanket is typically made of an elastomeric material such as rubber particularly formulated to be heat conductive or heat insulative dependent upon whether the fuser heat source is located within the core or in juxtaposition with the periphery of the blanket. An example of a fuser roller is disclosed in United Patent Application Publication U.S. 2004/0023144 A1, filed Aug. 4, 2003, in the names of Jerry A. Pickering and Alan R. Priebe, the contents of which are incorporated by reference as if fully set forth herein. The pressure member 118 may be similarly constructed, for example a metallic core (such as aluminum) covered by an elastomeric cushion (such as filled silicone elastomer), covered by a perfluoroalkoxy or tetrafluoroethylene plastic sleeve.

The cleaning blades of the invention may be mounted in numerous suitable ways, for example by retaining and/or clipping. The blades tend to heat during operation, so relatively large contiguous blades may be mounted in a manner that permits thermal expansion and contraction relative to the mount, for example a retainer with mounting holes elongated in a widthwise direction would allow the blade to expand and contract in the widthwise direction while remaining fully constrained. This may also be applied to narrower blades to the extent that relief for thermal expansion and contraction is desired.

According one aspect of the invention, the cleaning device is conformable to a surface to be cleaned. The cleaning device may be conformable across the width of a roller (or other moving surface) such as a heater roller or a pressure roller, and may be rendered more conformable than a single piece blade extending across the same widthwise distance. This feature may improve the cleaning characteristics of the cleaning device.

The claims should not be read as limited to the described order or elements unless stated to that effect. As used herein, “first”, “second”, and “third” are used for reference only, do not indicate any particular order, and are not intended to limit the invention. In addition, use of the term “means” in any claim is intended to invoke 35 U.S.C. §112, paragraph 6, and any claim without the word “means” is not so intended.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

What is claimed is:

1. A cleaning device for cleaning a moving surface in a printer, comprising:
a common mount;
a first cleaning blade defining a first edge configured to engage the moving surface in the printer and comprising a first marginal end opposite the first edge;
a second cleaning blade defining a second edge configured to engage the moving surface in the printer and comprising a second marginal end opposite the second edge;
the first marginal end and the second marginal end being held by the common mount.

2. The cleaning device of claim 1, the first cleaning blade and the second cleaning blade being superposed.

3. The cleaning device of claim 1, the first cleaning blade being disposed at one position along the axis, the second cleaning blade being disposed at another position along the axis.

4. The cleaning device of claim 1, the first cleaning blade and the second cleaning blade splaying away from each other toward the roller.

5. The cleaning device of claim 1 comprising:
a third cleaning blade defining a third edge in contact with the circumferential surface and comprising a third marginal end opposite the third edge;
the first marginal end, the second marginal end, and the third marginal end being held by the common mount.

6. The cleaning device of claim 5, the first cleaning blade, the second cleaning blade, and the third cleaning blade splaying away from each other toward the roller.

7. The cleaning device of claim 5, the first cleaning blade, the second cleaning blade, and the third cleaning blade being superposed.

8. A fuser assembly for a printer comprising:
a support;
a common mount held by the support;
a roller held by the support, the roller defining a circumferential surface and being rotatable about an axis relative to the support;
a first cleaning blade defining a first edge in contact with the circumferential surface and comprising a first marginal end opposite the first edge;
a second cleaning blade defining a second edge in contact with the circumferential surface and comprising a second marginal end opposite the second edge;
the first marginal end and the second marginal end being held by the common mount.

9. The fuser assembly of claim 8 the fusing surface comprising material deposited from pre-printed media.

10. The fuser assembly of claim 8, the first cleaning blade and the second cleaning blade being superposed.

11. The fuser assembly of claim 8, the first cleaning blade being disposed at one position along the axis, the second cleaning blade being disposed at another position along the axis.

12. The fuser assembly of claim 8, the first cleaning blade and the second cleaning blade splaying away from each other toward the roller.

13. The fuser assembly of claim 8 comprising:
a third cleaning blade defining a third edge in contact with the circumferential surface and comprising a third marginal end opposite the third edge;
the first marginal end, the second marginal end, and the third marginal end being held by the common mount.

14. The fuser assembly of claim 13, the first cleaning blade, the second cleaning blade, and the third cleaning blade splaying away from each other toward the roller.

15. The fuser assembly of claim 13, the first cleaning blade, the second cleaning blade, and the third cleaning blade being superposed.

16. A fusing process in a printer comprising:
rotating a roller held by a support about an axis relative to the support, the roller defining a circumferential surface,
a common mount being held by the support,
the common mount holding a first marginal end of a first cleaning blade that defines a first edge opposite the first marginal end, the first edge contacting the circumferential surface,
the common mount holding a second marginal end of a second cleaning blade that defines a second edge opposite the second marginal end, the second edge contacting the circumferential surface.

17. The process of claim 16 the first and second cleaning blade removing material deposited on the circumferential surface from pre-printed media.

18. The process of claim 16, the first cleaning blade and the second cleaning blade being superposed.

19. The process of claim 16, the first cleaning blade being disposed at one position along the axis, the second cleaning blade being disposed at another position along the axis.

20. The process of claim 16, the first cleaning blade and the second cleaning blade splaying away from each other toward the roller.

21. The process of claim 16 comprising:
a third cleaning blade defining a third edge in contact with the circumferential surface and comprising a third marginal end opposite the third edge;
the first marginal end, the second marginal end, and the third marginal end being held by the common mount.

22. The process of claim 21, the first cleaning blade, the second cleaning blade, and the third cleaning blade splaying away from each other toward the roller.

23. The process of claim 21, the first cleaning blade, the second cleaning blade, and the third cleaning blade being superposed.

24. A fuser assembly for a printer comprising:
a support;
a common mount held by the support;
a fusing surface held by the support and movable in a direction relative to the support;
a first cleaning blade defining a first edge in contact with the fusing surface and comprising a first marginal end opposite the first edge;
a second cleaning blade defining a second edge in contact with the fusing surface and comprising a second marginal end opposite the second edge;
the first marginal end and the second marginal end being held by the common mount.

25. The fuser assembly of claim 24 the fusing surface comprising material deposited from pre-printed media.

26. The fuser assembly of claim 24 comprising a belt that defines the fusing surface.

27. The fuser assembly of claim 24, the first cleaning blade and the second cleaning blade being superposed.

28. The fuser assembly of claim 24, the first cleaning blade being disposed at one position along the axis, the second cleaning blade being disposed at another position along the axis.

29. The fuser assembly of claim 24, the first cleaning blade and the second cleaning blade splaying away from each other toward the fusing surface.

30. The fuser assembly of claim 24 comprising:
a third cleaning blade defining a third edge in contact with the circumferential surface and comprising a third marginal end opposite the third edge;
the first marginal end, the second marginal end, and the third marginal end being held by the common mount.

31. The fuser assembly of claim 30, the first cleaning blade, the second cleaning blade, and the third cleaning blade splaying away from each other toward the fusing surface.

32. The fuser assembly of claim 30, the first cleaning blade, the second cleaning blade, and the third cleaning blade being superposed.

33. A fusing process in a printer comprising:
moving a fusing surface held by a support in a direction relative to the support,
a common mount being held by the support,
the common mount holding a first marginal end of a first cleaning blade that defines a first edge opposite the first marginal end, the first edge contacting the fusing surface,
the common mount holding a second marginal end of a second cleaning blade that defines a second edge opposite the second marginal end, the second edge contacting the fusing surface.

34. The process of claim 33, the first and second cleaning blade removing material deposited on the roller from pre-printed media.

35. The process of claim 33 comprising a belt that defines the fusing surface.

36. The process of claim 33, the first cleaning blade and the second cleaning blade being superposed.

37. The process of claim 33, the first cleaning blade being disposed at one position along the axis, the second cleaning blade being disposed at another position along the axis.

38. The process of claim 33, the first cleaning blade and the second cleaning blade splaying away from each other toward the fusing surface.

39. The process of claim 33 comprising:
a third cleaning blade defining a third edge in contact with the circumferential surface and comprising a third marginal end opposite the third edge;
the first marginal end, the second marginal end, and the third marginal end being held by the common mount.

40. The process of claim 39, the first cleaning blade, the second cleaning blade, and the third cleaning blade splaying away from each other toward the fusing surface.

41. The process of claim 39, the first cleaning blade, the second cleaning blade, and the third cleaning blade being superposed.
